(19) United States
(12) Patent Application Publication
(10) Pub. No.: US 2023/0267173 A1
(43) Pub. Date: Aug. 24, 2023

(54) Chip, Method, Accelerator, and System for Pooling Operation

(71) Applicant: Shenzhen Corerain Technologies Co., Ltd., Shenzhen (CN)

(72) Inventors: Jiadong Wang, Shenzhen (CN); Kuen Hung Tsoi, Shenzhen (CN); Xinyu Niu, Shenzhen (CN)

(21) Appl. No.: 18/156,374

(22) Filed: Jan. 18, 2023

(30) Foreign Application Priority Data
Feb. 22, 2022 (CN) 202210162604.0

(51) Int. Cl. G06F 17/16

(52) U.S. Cl. CPC G06F 17/16

(57) ABSTRACT

Disclosed are a chip, a method, an accelerator, and a system for pooling operation. The chip includes: a demultiplexer including a first input terminal, and first and second output terminals, and outputting a first matrix from the first input terminal via the first or second output terminals in response to a first control signal; a first memory connected to the first output terminal and outputting elements of the first matrix stored by the first memory in response to a second control signal; a second memory connected to the second output terminal and serially outputting elements of a second matrix in the first matrix stored by the second memory in response to a third control signal; and a computation circuit performing a pooling operation on the second matrix from the first memory or the second memory to obtain an operation result in response to a fourth control signal.

### CROSS REFERENCE TO RELATED APPLICATIONS

The present application claims the benefit of Chinese Patent Application No. 202210162604.0 filed on Feb. 22, 2022, the contents of which are incorporated herein by reference in their entirety.

### FIELD

The present disclosure relates to the technical field of artificial intelligence, and more particularly, to a chip, a method, an accelerator, and a system for pooling operation.

### BACKGROUND

Pooling operation is common in neural network operations, which can reduce the dimension of input data by sampling. The pooling operation includes a max pooling operation and an average pooling operation, where a pooling window is moved to obtain a largest value or an average value of data in a plurality of pooling windows.

The efficiency of the pooling operation affects the efficiency of the neural network operation. In the prior art, acceleration of the pooling operation may be enabled by hardware accelerators.

### SUMMARY

Nevertheless, the inventors note that accelerators in the prior art cannot ensure operation speed and versatility both. Accelerators either accelerate all pooling operations, resulting in a low overall operation speed, or increase only the operation speed of a particular pooling operation with poor versatility.

In view of the above problem, the embodiments of the present disclosure provide the following technical solution.

In an aspect of the embodiments of the present disclosure, a chip for pooling operation is provided, including: a demultiplexer including a first input terminal, a first output terminal, and a second output terminal and configured to output a first matrix from the first input terminal via the first output terminal or the second output terminal in response to a first control signal; a first memory connected to the first output terminal and configured to perform a plurality of outputs to output each element of the first matrix stored by the first memory in response to a second control signal, outputting a column of elements of the first matrix in parallel for each output; a second memory connected to the second output terminal and configured to serially output each element of a second matrix in the first matrix stored by the second memory in response to a third control signal; and a computation circuit configured to perform a pooling operation on the second matrix from the first memory or the second memory to obtain an operation result in response to a fourth control signal.

In some embodiments, the first memory includes at least one row buffer connected to the first output terminal, each row buffer being configured to store a row of elements in the first matrix.

In some embodiments, each row buffer includes one or more first-in-first-out memories that are connected in series.

In some embodiments, the at least one row buffer includes N row buffers, different row buffers being configured to store different rows of elements in the first matrix, N being an integer greater than or equal to 2.

In some embodiments, the N row buffers are sequentially connected in series, a 1st row buffer of the N row buffers is connected to the first output terminal, an i-th row buffer is configured to output a row of elements flowing to the i-th row buffer to an (i+1)th row buffer so that different row buffers store different rows of elements in the first matrix, and i is an integer greater than or equal to 1 and less than or equal to N−1.

In some embodiments, the i-th row buffer is configured to output one element to the (i+1)th row buffer each time the element is output to the computation circuit.

In some embodiments, the first memory further includes a data path connected to the first output terminal and in parallel with the at least one row buffer and configured such that a first row of elements or a last row of elements in the first matrix flow out via the data path.

In some embodiments, the computation circuit is configured to determine the second matrix on the basis of the first matrix from the first memory in response to the fourth control signal and to perform the pooling operation on the second matrix to obtain the operation result.

In some embodiments, the second matrix includes a 1st second matrix and a 2nd second matrix; the computation circuit is configured to perform a first pooling operation on a plurality of first elements of the 1st second matrix to obtain a first operation result, wherein the first pooling operation includes: performing a first operation on each column of first elements in the plurality of first elements to obtain a first intermediate result, and performing a second operation on the first intermediate result of each column of first elements to obtain the first operation result; and the computation circuit is further configured to perform a second pooling operation on a plurality of second elements of the 2nd second matrix to obtain a second operation result, wherein at least one column of the plurality of second elements is the same as at least one column of the plurality of first elements, and the second pooling operation includes: performing the first operation on each column of second elements of the plurality of second elements except the at least one column of second elements to obtain a second intermediate result, and performing the second operation on the first intermediate result and the second intermediate result of the at least one column of first elements to obtain the second operation result.

In some embodiments, the computation circuit includes: a first computation circuit configured to perform the first operation to obtain the first intermediate result and the second intermediate result; and a second computation circuit configured to perform the second operation to obtain the second operation result after obtaining the first intermediate result and the second intermediate result of the at least one column of first elements by the first computation circuit.

In some embodiments, in a case where the first intermediate result of each column of first elements is a sum of the first elements of the column, the first operation result is an average value of a plurality of first elements of the 1st second matrix, and the second operation result is an average value of a plurality of second elements of the 2nd second matrix; and in a case where the first intermediate result of each column of first elements is a max-or-min value of the first elements of the column, the first operation result is a max-or-min value of a plurality of first elements of the 1st second matrix, and the second operation result is a max-or-min value of a plurality of second elements of the 2nd second matrix, the max-or-min value being one of a largest value and a smallest value.

In some embodiments, the second memory is configured to determine the second matrix from the first matrix stored by the second memory and serially output each element of the second matrix to the computation circuit in response to the third control signal.

In some embodiments, the chip for pooling operation further includes a multiplexer including a second input terminal, a third input terminal, and a third output terminal and configured to output the first matrix from the second input terminal or the second matrix from the third input terminal via the third output terminal in response to a fifth control signal, wherein the second input terminal is connected to the first memory, the third input terminal is connected to the second memory, and the third output terminal is connected to the computation circuit.

In some embodiments, the chip for pooling operation further includes a data collator configured to collate a plurality of the operation results into a preset format and output in response to a sixth control signal.

In some embodiments, the chip for pooling operation further includes a first controller configured to transmit a plurality of control signals, the plurality of control signals including the first control signal, the second control signal, the third control signal, and the fourth control signal.

In another aspect of the embodiments of the present disclosure, a method for pooling operation is provided, including: outputting by a demultiplexer a first matrix from a first input terminal of the demultiplexer via a first output terminal of the demultiplexer or via a second output terminal of the demultiplexer in response to a first control signal; performing multiple outputs by a first memory to output each element of the first matrix stored by the first memory and output a column of elements of the first matrix in parallel each time in response to a second control signal in the case where the first matrix is output via the first output terminal, the first memory being connected to the first output terminal; outputting serially by a second memory each element of a second matrix in the first matrix stored by the second memory in response to a third control signal in the case where the first matrix is output via the second output terminal, the second memory being connected to the second output terminal; and performing a pooling operation by a computation circuit on the second matrix from the first memory or the second memory to obtain an operation result in response to a fourth control signal.

In some embodiments, the first memory includes at least one row buffer connected to the first output terminal, each row buffer storing a row of elements of the first matrix.

In some embodiments, each of the row buffers includes one or more first-in-first-out memories that are connected in series.

In some embodiments, the at least one row buffer includes N row buffers, different row buffers storing different rows of elements in the first matrix, N being an integer greater than or equal to 2.

In some embodiments, the N row buffers are sequentially connected in series, and a 1st row buffer of the N row buffers is connected to the first output terminal; the method further includes: outputting by an i-th row buffer a row of elements flowing to the i-th row buffer to an (i+1)th row buffer so that different row buffers store different rows of elements in the first matrix, where i is an integer greater than or equal to 1 and less than or equal to N−1.

In some embodiments, the i-th row buffer outputs one element to the (i+1)th row buffer each time the element is output to the computation circuit.

In yet another aspect of the embodiments of the present disclosure, an accelerator for pooling operation is provided, including the chip for pooling operation as described in any of the embodiments above.

In still another aspect of the embodiments of the present disclosure, a system for pooling operation is provided, including: the accelerator for pooling operation according to any of the above embodiments; a third memory configured to store a third matrix; a direct memory access module configured to retrieve the first matrix from the third matrix and transmit to the demultiplexer in response to a seventh control signal; and a second controller configured to transmit the seventh control signal and an eighth control signal, the eighth control signal causing the first control signal, the second control signal, the third control signal, and the fourth control signal to be transmitted.

In the embodiments of the present disclosure, the first memory can output matrix elements in parallel, which facilitate the speed of the pooling operation; since the second memory only needs to serially output the matrix elements corresponding to a pooling window, various parameters can be applicable for the pooling window, which renders good versatility. Two types of memories are provided, which considers both high speed and versatility, thereby satisfying a variety of operational requirements. Furthermore, the computation circuit connected to the first memory and the computation circuit connected to the second memory connection may be the same one, which is advantageous for an improved area efficiency of the chip.

The embodiments of the present disclosure are described in further detail below with reference to the accompanying drawings and examples.

### BRIEF DESCRIPTION OF THE DRAWINGS

In order that the present disclosure or the technical solutions in the prior art are illustrated more clearly, a brief description will be given below with reference to the accompanying drawings which are used in the description of the embodiments or the prior art. Apparently, the drawings in the description below are only some of the embodiments of the present disclosure, and those of ordinary skill in the art can readily devise other drawings on such a basis without involving any inventive effort.

FIG. 1 is a block diagram of a chip for pooling operation according to some embodiments of the present disclosure.

FIG. 2 is a schematic diagram of a first matrix and a second matrix according to some embodiments of the present disclosure.

FIG. 3 is a schematic diagram of a structure of a first memory according to some embodiments of the present disclosure.

FIG. 4 is a flow chart of a method for the first memory to store the first matrix according to some embodiments of the present disclosure.

FIG. 5 is a flow chart of a method for pooling operation according to some embodiments of the present disclosure.

FIG. 6 is a block diagram of a system for pooling operation according to some embodiments of the present disclosure.

FIG. 7 is a schematic diagram of a third matrix according to some embodiments of the present disclosure.

### DETAILED DESCRIPTION

The technical solutions in the embodiments of the present disclosure will be clearly and completely described below with reference to the drawings in the embodiments of the present disclosure. Apparently, the described embodiments are only some of the embodiments of the present disclosure, not all of them. All other embodiments obtained by persons of ordinary skill in the art on the basis of the embodiments in the present disclosure without inventive efforts shall fall within the scope of the present disclosure.

The relative arrangement of parts and steps, numerical expressions and numerical values set forth in these embodiments do not limit the scope of the disclosure unless specifically stated otherwise.

It should also be understood that the dimensions of the various parts illustrated in the drawings are not drawn to scale for ease of description.

Techniques, methods, and devices known to those of ordinary skill in the relevant art may not be discussed in detail but should be considered part of the written description where appropriate.

In all embodiments shown and discussed herein, any particular value shall be interpreted as illustrative only and not as limiting. Therefore, other examples of exemplary embodiments may have different values.

It should be noted that like reference signs and letters refer to like items in the following drawings, and thus once an item is defined in one figure, further explanation thereof is not required in subsequent figures.

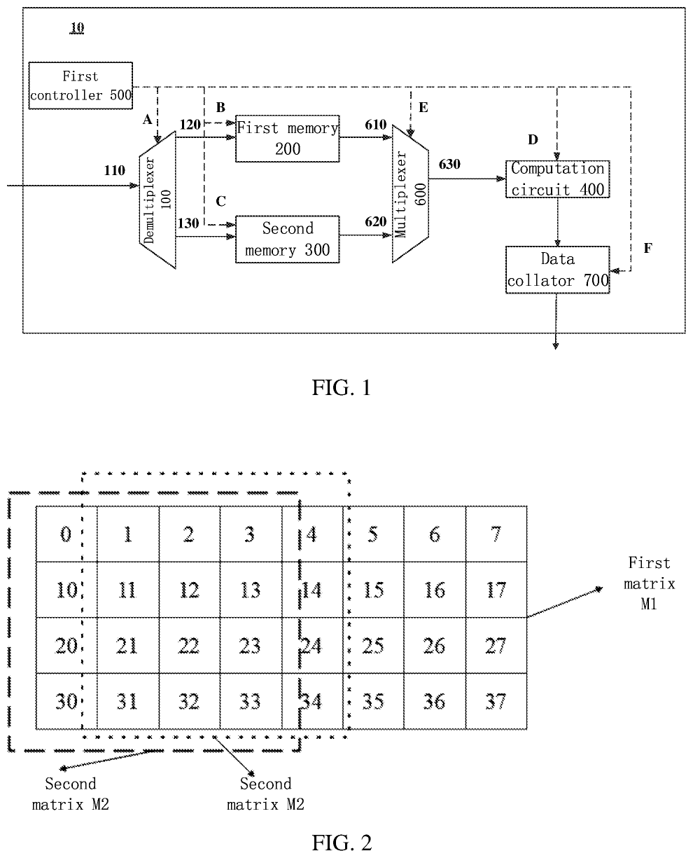

FIG. 1 is a block diagram of a chip for pooling operation according to some embodiments of the present disclosure. FIG. 2 is a schematic diagram of a first matrix and a second matrix according to some embodiments of the present disclosure.

As shown in FIG. 1, the chip for pooling operation 10 includes a demultiplexer 100, a first memory 200, a second memory 300, and a computation circuit 400.

The demultiplexer 100 includes a first input terminal 110, a first output terminal 120, and a second output terminal 130, the demultiplexer 100 being configured to output a first matrix M1 from the first input terminal 110 via the first output terminal 120 or the second output terminal 130 in response to a first control signal A.

For example, as shown in FIG. 2, the first matrix M1 is a 4 (row)×8 (column) matrix.

In the case where the first matrix M1 is output via the first output terminal 120, the first matrix M1 is output to the first memory 200 connected to the first output terminal 120.

In the case where the first matrix M1 is output via the second output terminal 130, the first matrix M1 is output to a second memory connected to the second output terminal 130.

In some implementations, a user may select whether the first matrix M1 is output to the first memory 200 or the second memory 300. In this case, the first control signal A may be transmitted according to the user's selection.

In further implementations, the chip for pooling operation 10 may also automatically control the output of the first matrix M1. Since the pooling operation via the first memory 200 is faster, in general, the first matrix M1 can be output to the first memory 200. If the first memory 200 is unable to process some of the pooling operations (e.g., the memory space of the first memory 200 is insufficient to store the first matrix M1), the first matrix M1 may be output to the second memory 300. In this case, the first control signal A may be transmitted according to a current space of the first memory 200.

The first memory 200 is configured to perform a plurality of outputs to output each element of the first matrix M1 stored by the first memory 200 in response to a second control signal B. Here, the first memory 200 outputs one column of elements of the first matrix M1 in parallel every time the output is performed.

For example, for the first matrix M1 as shown in FIG. 2, the first memory 200 outputs 0, 10, 20 and 30 in parallel for the first time of output; for the second output, the first memory 200 outputs 1, 11, 21 and 31 in parallel.

The second memory 300 is connected to the second output terminal 130 and configured to serially output each element of the second matrix M2 in the first matrix M1 stored in the second memory 300 in response to a third control signal C. Here, the second matrix M2 is a matrix corresponding to the pooling window.

For example, FIG. 2 shows two 4 (row)×4 (column) second matrices M2, and as the pooling window moves, the second matrix M2 corresponding to the pooling window may be determined. When the second matrix M2 relatively to the left is output, the second memory 300 outputs elements 0, 1, 2, 3, 10, 11, 12, 13, 20, 21, 22, 23, 30, 31, 32, 21, 22, 23, 30, 31, 32, and 33 one by one. When the second matrix M2 relatively to the right is output, the second memory 300 outputs elements 1, 2, 3, 4, 11, 12, 13, 14, 21, 22, 23, 24, 31, 32, 33, 22, 23, 24, 31, 32, 33 and 34 one by one.

The computation circuit 400 is configured to perform a pooling operation on the second matrix M2 from the first memory 200 or the second memory 300 to obtain an operation result in response to a fourth control signal D.

In the above embodiments, the first memory 200 can output matrix elements in parallel, which facilitate the speed of pooling operation; since the second memory 300 only needs to serially output the matrix elements corresponding to a pooling window, various parameters can be applicable for the pooling window, which renders good versatility. Two types of memories are provided, which considers both high speed and versatility, thereby satisfying a variety of operational requirements. Furthermore, the computation circuit 400 connected to the first memory 200 and the computation circuit 400 connected to the second memory 300 connection may be the same one, which is advantageous for an improved area efficiency of the chip.

In some embodiments, as shown in FIG. 1, the chip for pooling operation 10 also includes a first controller 500. The first controller 500 is configured to transmit a plurality of control signals including the first control signal A, the second control signal B, the third control signal C, and the fourth control signal D. It should be understood that the first controller 500 may correspondingly transmit a plurality of control signals to control the demultiplexer 100, the first memory 200, the second memory 300, and the computation circuit 400 to perform corresponding operations according to different operation requirements.

In some embodiments, as shown in FIG. 1, the chip for pooling operation 10 also includes a multiplexer 600. The multiplexer 600 includes a second input terminal 610, a third input terminal 620, and a third output terminal 630, the multiplexer 600 being configured to output the first matrix M1 from the second input terminal 610 or the second matrix M2 from the third input terminal 620 via the third output terminal 630 in response to a fifth control signal E. Herein, the second input terminal 610 is connected to the first memory 200, the third input terminal 620 is connected to the second memory 300, and the third output terminal 630 is connected to the computation circuit 400.

For example, the fifth control signal E may be transmitted by the first controller 500. In other words, the plurality of control signals that the first controller 500 is configured to transmit further includes the fifth control signal E.

In some embodiments, as shown in FIG. 1, the chip for pooling operation 10 also includes a data collator 700. The data collator 700 is configured to collate a plurality of operation results into a preset format and output in response to a sixth control signal F. It will be appreciated that one operation result may be obtained each time the computation circuit performs one pooling operation on one second matrix M2. For example, a matrix in a 5 (row)×1 (column) preset format is given.

In some embodiments, the sixth control signal F may be transmitted by the first controller 500. In other words, the plurality of control signals that the first controller 500 is configured to transmit further includes the sixth control signal F.

A structure of the first memory 200 is described below in connection with some embodiments.

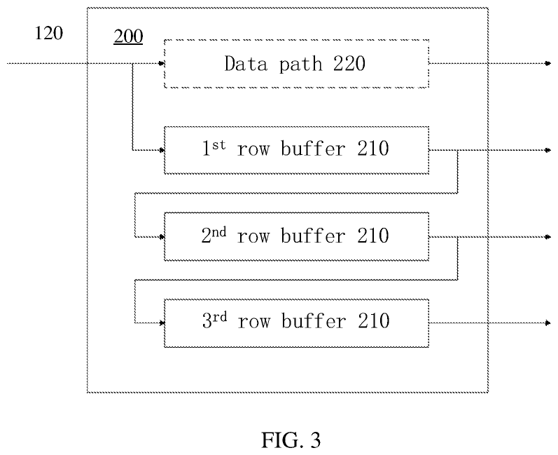

FIG. 3 is a schematic diagram of a structure of a first memory according to some embodiments of the present disclosure.

In some embodiments, as shown in FIG. 3, the first memory 200 includes at least one row buffer 210. The at least one row buffer 210 is connected to the first output terminal 120, each row buffer 210 being configured to store a row of elements in the first matrix M1. A number of the row buffers may be determined from a number of rows of the first matrix M1; for example, the number of the row buffers may be equal to the number of rows of the first matrix M1.

In some implementations, each of the row buffers 210 may include one or more first-in-first-out (FIFO) memories in series. For example, a number of the first-in-first-out memories and a depth and bit width of each first-in-first-out memory may be set according to parameters such as a number of columns of the first matrix M1 and a dimension of the elements of the first matrix M1.

The first memory 200 may include only one row buffer 210 or may include a plurality of row buffers 210. In some embodiments, as shown in FIG. 3, the first memory 200 may also include a data path 220 so that in a case where the first memory 200 includes only one row buffer 210, a parallel output of multiple rows of elements is still possible, which will be described below in conjunction with various embodiments.

In some embodiments, as shown in FIG. 3, the first memory 200 includes N row buffers 210 (N is an integer greater than or equal to 2, and FIG. 3 schematically shows a case where N is 3). Different row buffers 210 are configured to store different rows of elements in the first matrix M1. Here, N is equal to the number of rows of the first matrix M1. It should be appreciated that the N row buffers 210 are configured to store N rows of elements in the first matrix M1, respectively.

In the above embodiments, N row buffers 210 are used to store data of different rows, which facilitates the subsequent parallel output of multiple rows of data and the parallel operation of the computation circuit, thereby improving the operation speed.

The N row buffers 210 may be connected in series or in parallel, which will be both described below as to how different row buffers 210 store different rows of elements in the first matrix M1.

Firstly, the case where the N row buffers 210 are connected in parallel will be described.

In this case, each row buffer 210 is connected to the first output terminal 120. Each row buffer 210 stores a different row of elements of the first matrix M1. For example, a 1st row buffer stores a first row of elements of the first matrix M1, a 2nd row buffer stores a second row of elements of the first matrix M1, a 3rd row buffer stores a third row of elements of the first matrix M1, and so on.

Next, the case where the N row buffers 210 are connected in series will be described.

In some embodiments, as shown in FIG. 3, N row buffers 210 are serially connected in sequence, a 1st row buffer 210 of the N row buffers 210 is connected to the first output terminal 120, and an i-th row buffer 210 is configured to output a row of elements flowing to the i-th row buffer 210 to an (i+1)th row buffer 210, so that different row buffers 210 store different rows of elements in the first matrix M1, where i is an integer greater than or equal to 1 and less than or equal to N−1.

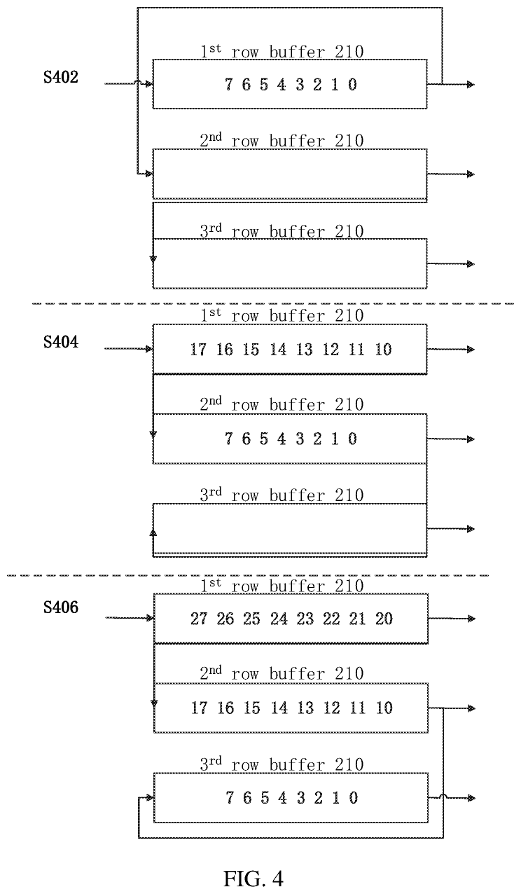

A process of storing the first matrix M1 by the first memory will be described below with reference to FIG. 4.

FIG. 4 is a flow chart of a method for the first memory to store the first matrix according to some embodiments of the present disclosure.

As shown in FIG. 4, in step S402, a first row of elements, i.e., 0, 1, 2, 3, 4, 5, 6, and 7, of the first matrix M1 flow to the 1st row buffer 210.

In step S404, the 1st row buffer 210 outputs the elements 0, 1, 2, 3, 4, 5, 6, and 7 flowing to the 1st row buffer 210 to the 2nd row buffer 210, and a second row of elements, i.e., 10, 11, 12, 13, 14, 15, 16, and 17, of the first matrix M1 flow to the 1st row buffer 210. For example, the 1st row buffer 210 may have one element flowing therein after each output of one element.

In step S406, the 2nd row buffer 210 outputs elements 0, 1, 2, 3, 4, 5, 6, and 7 flowing to the 2nd row buffer 210 to the 3rd row buffer 210, the 1st row buffer 210 outputs elements 10, 11, 12, 13, 14, 15, 16, and 17 flowing to the 1st row buffer 210 to the 2nd row buffer 210, and a third row of elements, i.e., 20, 21, 22, 23, 24, 25, 26, and 27, of the first matrix M1 flow to the 1st row buffer 210.

Through the above steps, the first matrix M1 is stored in a plurality of row buffers, respectively. On the one hand, such a process is beneficial to realize the parallel output of the elements and facilitate the parallel operation of the computation circuit, so as to improve the operation speed; on the other hand, the first matrix M1 is stored more simply and accurately.

A process of outputting data from the first memory 200 will be described below.

In some embodiments, the i-th row buffer 210 is configured to output an element to the (i+1)th row buffer 210 each time the element is output to the computation circuit 400.

For example, the output of the elements is started when the first matrix M1 is stored in the N row buffers 210 connected serially in sequence. The 1st row buffer 210 may also output one element of the third row of elements, i.e., 20, 21, 22, 23, 24, 25, 26, and 27, of the first matrix M1 to the 2nd row buffer 210 each time the element is output to the computation circuit 400. Similarly, the 2nd row buffer 210 may also output one element of the second row of elements, i.e., 10, 11, 12, 13, 14, 15, 16, and 17, of the first matrix M1 to the 3rd row buffer 210 each time the element is output to the computation circuit 400.

As such, the second row of elements, i.e., 10, 11, 12, 13, 14, 15, 16, and 17, of the first matrix M1 and the third row of elements, i.e., 20, 21, 22, 23, 24, 25, 26, and 27, of the first matrix M1 have been stored in the first memory 200 when a movement of the pooling window in a row direction ends and a movement of the pooling window in a column direction begins. When the second row of elements and the third row of elements need to be used again for the pooling window (for example, a stride of the pooling window moving in the column direction is 1), since the second row of elements and the third row of elements are already stored in the row buffer 210, the first memory 200 does not need to repeatedly acquire and store these elements from the outside, reducing the time required for storing data; therefore, the computation circuit 400 performs subsequent operations more quickly, which further improves the operation speed of the chip.

In some embodiments, as shown in FIG. 3, the first memory 200 further includes the data path 220 connected to the first output terminal 120 and in parallel with the at least one row buffer 210, the data path 220 being configured such that the first row of elements or a last row of elements in the first matrix M1 flow out via the data path 220.

For example, the last row of elements, i.e., 30, 31, 32, 33, 34, 35, 36, and 37, of the first matrix M1 flow out via the data path 220.

It should be understood that the outflow of elements via the data path 220 may be synchronized with the output from the row buffer 210; for example, the 1st row buffer 210 outputting element 20, the 2nd row buffer 210 outputting element 10, the 3rd row buffer 210 outputting element 0, and the element 30 flowing out via the data path 220 may be done synchronously.

In the above embodiments, the configuration of the data path 220 advantageously reduces the number of row buffers 210 required for storage, thereby reducing the size of the chip.

In some embodiments, the computation circuit 400 is configured to determine a second matrix M2 on the basis of the first matrix M1 from the first memory 200 in response to the fourth control signal D and perform a pooling operation on the determined second matrix M2 to obtain an operation result.

In some embodiments, the second matrix M2 includes a 1st second matrix M2 and a 2nd second matrix M2; the computation circuit 400 is configured to perform a first pooling operation on a plurality of first elements of the 1st second matrix M2 to obtain a first operation result. Here, performing the first pooling operation includes: performing a first operation on each column of first elements in the plurality of first elements to obtain a first intermediate result, and performing a second operation on the first intermediate result of each column of first elements to obtain a first operation result. For example, the 1st second matrix M2 is the second matrix M2 relatively to the left in FIG. 2. Firstly, largest values are derived for four columns of first elements of the 1st second matrix, respectively (i.e., the first operation), to obtain the largest value of each column of first elements (i.e., the first intermediate result), namely, 30, 31, 32 and 33. Next, a largest value is then derived for 30, 31, 32 and 33 (i.e., the second operation), to obtain the largest value of the plurality of first elements of the 1st second matrix M2 (i.e., the first operation result), namely, 33.

The computation circuit 400 is further configured to perform a second pooling operation on a plurality of second elements of the 2nd second matrix M2 from the first memory 200 to obtain a second operation result, wherein at least one column of the plurality of second elements is the same as at least one column of the plurality of first elements. Performing the second pooling operation includes: performing the first operation on each column of second elements of the plurality of second elements except the at least one column of second elements to obtain a second intermediate result, and performing the second operation on the first intermediate result and the second intermediate result of the at least one column of first elements to obtain the second operation result. For example, the 2nd second matrix M2 is the second matrix M2 relatively to the right in FIG. 2, and in this case, the first three columns of second elements of the 2nd second matrix M2 are the same as the last three columns of first elements of the 1st second matrix M2. Firstly, a largest value is derived for a fourth column of second elements, i.e., 4, 14, 24, and 34, of the 2nd second matrix M2 to obtain the second intermediate result, namely, 34, of this column of second elements. Next, a largest value is derived for the first intermediate results 31, 32, 33 of the last three columns of first elements of the 1st second matrix M2 (i.e., the first three columns of the second elements of the 2nd second matrix M2) and the second intermediate result 34 to obtain the largest value of the plurality of second elements of the 2nd second matrix M2 (i.e., the second operation result), namely, 34.

In the above embodiments, in a case where the pooling window moves in the row direction and repeated operations are performed on a certain column of elements, the intermediate result of an operation on the column of elements is saved for use in the repeated operations, which is beneficial to reduce the workload of repeated operation, thereby further improving the operation speed.

In some embodiments, the computation circuit 400 includes a first computation circuit and a second computation circuit. The first computation circuit is configured to perform the first operation to obtain the first intermediate result and the second intermediate result. The second computation circuit is configured to perform the second operation to obtain the second operation result after obtaining the first intermediate result and the second intermediate result for the at least one column of first elements from the first computation circuit.

Here, the computation circuit 400 may be composed of at least one of an adder, a multiplier, and a comparator. For example, the first computation circuit may be composed of a plurality of adders, and the second computation circuit may be composed of a plurality of adders and one multiplier.

In some embodiments, in a case where the first intermediate result of each column of first elements is a sum of the first elements of the column, the first operation result is an average value of a plurality of first elements of the 1st second matrix M2, and the second operation result is an average value of a plurality of second elements of the 2nd second matrix M2.

In some embodiments, in a case where the first intermediate result of each column of first elements is a max-or-min value of the first elements of the column, the first operation result is a max-or-min value of a plurality of first elements of the 1st second matrix M2, and the second operation result is a max-or-min value of a plurality of second elements of the 2nd second matrix M2.

Here, the max-or-min value is one of a largest value and a smallest value. For example, in the case where the first intermediate result is the largest value of the column of first elements, the first operation result is the largest value of the first elements of the 1st second matrix M2, and the second operation result is the largest value of the second elements of the 2nd second matrix M2.

In some embodiments, the fourth control signal D may carry an operation range determined according to the stride of the pooling window moving in the row direction and the column direction, and the computation circuit 400 performs the pooling operation only on the elements within the operation range (i.e., the second matrix M2) in response to the fourth control signal D.

The working mode of the second memory 300 is described below in connection with some embodiments.

In some embodiments, the second memory 300 is configured to determine the second matrix M2 from the first matrix M1 stored in the second memory 300 and serially output each element of the second matrix M2 to the computation circuit 400 in response to the third control signal C.

For example, the third control signal C may carry information like a number, a starting point, and an ending point of the elements of the second matrix M2, and after receiving the third control signal C, the second memory 300 marks the relevant elements, splits the second matrix M2 from the first matrix M1, and transmits to the computation circuit 400.

Each of the embodiments described in this specification is based on a preceding one, each focusing on differences from the other embodiments, and reference may be made to other embodiments to understand the same or similar parts. Since the embodiments of the method substantially correspond to the embodiments of the chip, the description thereof is relatively simple, and reference may be made to the embodiments of the chip to understand some relevant parts.

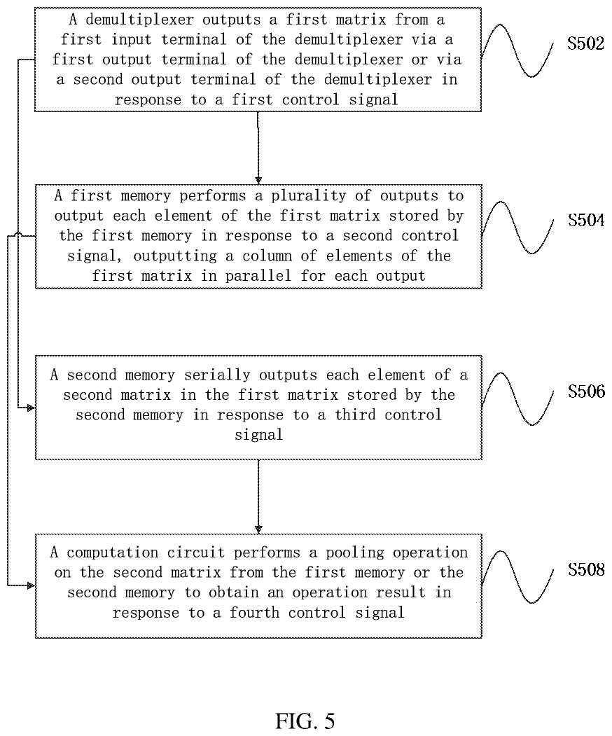

FIG. 5 is a flow chart of a method for pooling operation according to some embodiments of the present disclosure.

In step S502, the demultiplexer 100 outputs the first matrix M1 from the first input terminal 110 of the demultiplexer 100 via the first output terminal 120 of the demultiplexer 100 or the second output terminal 130 of the demultiplexer 100 in response to the first control signal A.

In the case where the first matrix M1 is output via the first output terminal 120, the process goes to step S504; in the case where the first matrix M1 is output via the second output terminal 130, the process goes to step S506.

In step S504, the first memory 200 performs a plurality of outputs to output each element of the first matrix M1 stored in the first memory 200 in response to the second control signal B, outputting a column of elements of the first matrix M1 in parallel for each output. Here, the first memory 200 is connected to the first output terminal 120.

In step S506, the second memory 300 serially outputs each element of the second matrix M2 in the first matrix M1 stored in the second memory 300 in response to the third control signal C. Here, the second memory 300 is connected to the second output terminal 130.

In step S508, the computation circuit 400 performs a pooling operation on the second matrix M2 from the first memory 200 or the second memory 300 in response to the fourth control signal D to obtain an operation result.

In the above embodiments, the first memory 200 can output matrix elements in parallel, which facilitate the speed of pooling operation; since the second memory 300 only needs to serially output the matrix elements corresponding to a pooling window, various parameters can be applicable for the pooling window, which renders good versatility. Two types of memories are provided, which considers both high speed and versatility, thereby satisfying a variety of operational requirements. Furthermore, the computation circuit 400 connected to the first memory 200 and the computation circuit 400 connected to the second memory 300 connection may be the same one, which is advantageous for an improved area efficiency of the chip.

In some embodiments, the first memory 200 includes at least one row buffer 210 connected to the first output terminal 120, each row buffer 210 storing a row of elements in the first matrix M1. The number of the row buffers may be determined from the number of rows of the first matrix M1; for example, the number of the row buffers may be equal to the number of rows of the first matrix M1.

In some embodiments, each row buffer includes one or more first-in-first-out memories in series. For example, the number of first-in-first-out memories and the depth and bit width of each first-in-first-out memory may be set according to parameters such as the number of columns of the first matrix M1 and the dimension of the elements of the first matrix M1.

In some embodiments, the at least one row buffer 210 includes N row buffers 210, different row buffers 210 storing different rows of elements in the first matrix M1, N being an integer greater than or equal to 2.

In the above embodiments, N row buffers 210 are taken to store data of different rows, which facilitates the subsequent parallel output of multiple rows of data and the parallel operation of the computation circuit, thereby improving the operation speed.

In some embodiments, the N row buffers 210 are connected serially in sequence, and the 1st row buffer 210 of the N row buffers 210 is connected to the first output terminal 120; the i-th row buffer 210 outputs a row of elements flowing to the i-th row buffer 210 to the (i+1)th row buffer 210 such that different row buffers 210 store different rows of elements in the first matrix M1, i being an integer greater than or equal to 1 and less than or equal to N−1.

In the above embodiments, the first matrix M1 is stored in a plurality of row buffers, respectively. On the one hand, such a process is beneficial to realize the parallel output of the elements and facilitate the parallel operation of the computation circuit, so as to improve the operation speed; on the other hand, the first matrix M1 is stored more simply and accurately.

In some embodiments, the i-th row buffer 210 also outputs an element to the (i+1)th row buffer 210 each time the element is output to the computation circuit 400.

In some embodiments, the first memory 200 further includes the data path 220 connected to the first output terminal 120 and in parallel with the at least one row buffer 210, wherein the first row of elements or the last row of elements in the first matrix M1 flow out via the data path 220. the configuration of the data path 220 advantageously reduces the number of row buffers 210 required for storage, thereby reducing the size of the chip.

In some embodiments, the computation circuit 400 determines the second matrix M2 on the basis of the first matrix M1 from the first memory 200 in response to the fourth control signal D and performs a pooling operation on the second matrix M2 to obtain an operation result.

In some embodiments, the second matrix M2 includes a 1st second matrix M2 and a 2nd second matrix M2; the computation circuit 400 performs a first pooling operation on a plurality of first elements of the 1st second matrix M2 to obtain a first operation result. Herein, the first pooling operation includes: performing a first operation on each column of first elements in the plurality of first elements to obtain a first intermediate result, and performing a second operation on the first intermediate result of each column of first elements to obtain a first operation result.

The computation circuit 400 performs a second pooling operation on a plurality of second elements of the 2nd second matrix M2 to obtain a second operation result. Herein, at least one column of the plurality of second elements is the same as at least one column of the plurality of first elements.

The second pooling operation includes: performing the first operation on each column of second elements of the plurality of second elements except the at least one column of second elements to obtain a second intermediate result, and performing the second operation on the first intermediate result and the second intermediate result of the at least one column of first elements to obtain the second operation result.

In some embodiments, the computation circuit 400 includes a first computation circuit and a second computation circuit. The first computation circuit performs the first operation to obtain the first intermediate result and the second intermediate result. The second computation circuit performs the second operation to obtain the second operation result after obtaining the first intermediate result and the second intermediate result for the at least one column of first elements from the first computation circuit.

The present disclosure also provides an accelerator for pooling operation, including the chip for pooling operation according to any of the embodiments described above.

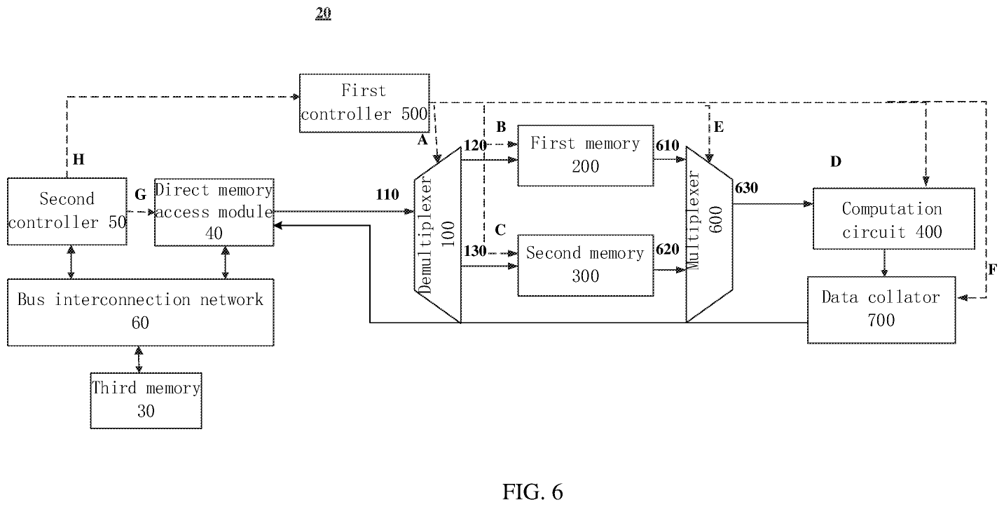

FIG. 6 is a block diagram of a system for pooling operation according to some embodiments of the present disclosure.

As shown in FIG. 6, the pooling operation system includes an accelerator for pooling operation 20, including any of the embodiments described above (e.g., including the chip for pooling operation 10 shown in FIG. 1), a third memory 30, a direct memory access module 40, and a second controller 50.

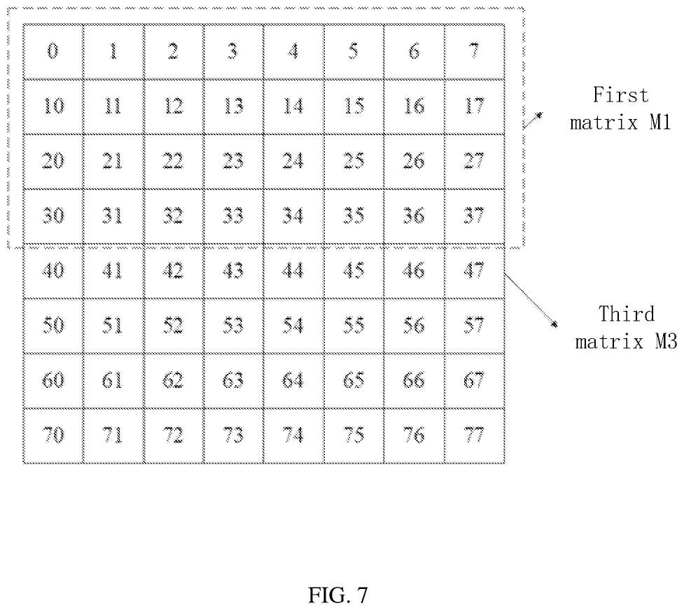

The third memory 30 is configured to store a third matrix M3. FIG. 7 is a schematic diagram of a third matrix according to some embodiments of the present disclosure. As shown in FIG. 7, the third matrix M3 is an 8 (row)×8 (column) matrix. In some embodiments, the third memory 30 may also store other data, such as data output by the chip for pooling operation 10.

The direct memory access module 40 is configured to retrieve the first matrix M1 from the third matrix M3 and transmit to the demultiplexer 100 in the chip for pooling operation 10 in response to a seventh control signal G. For example, the first four rows are taken as the first matrix M1 from the third matrix M3 as shown in FIG. 7, and the first matrix M1 is transmitted to the demultiplexer 100. In some embodiments, the direct memory access module 40 may also receive data output by the chip for pooling operation 10 and transmit to the third memory 30.

The second controller 50 is configured to transmit the seventh control signal G and an eighth control signal H, the eighth control signal H causing the first control signal A, the second control signal B, the third control signal C, and the fourth control signal D to be transmitted. For example, the second controller 50 may be a CPU or the like. In some embodiments, the eighth control signal H may also cause the fifth control signal E and the sixth control signal F to be transmitted, that is, the second controller 50 may control the first controller 500 to transmit a respective control signal through the eighth control signal H.

In some embodiments, data communication among the second controller 50, the direct memory access module 40, and the third memory 30 may also be accomplished via a bus interconnection network 60.

Various embodiments of the present disclosure are described in detail above. To avoid obscuring the concepts of the present disclosure, some details known in the art are not described. From the above description, those skilled in the art will fully understand how to implement the technical solutions disclosed herein.

While specific embodiments of the disclosure are described in detail by way of example, it will be understood by those skilled in the art that the foregoing examples are illustrative only and are not intended to limit the scope of the disclosure. It will be appreciated by those skilled in the art that changes may be made to the above embodiments or equivalent substitutions of elements herein may be made without departing from the scope and spirit of the disclosure. The scope of the disclosure is defined by the appended claims.

What is claimed is:

1. A chip for pooling operation, comprising:
a demultiplexer comprising a first input terminal, a first output terminal, and a second output terminal and configured to output a first matrix from the first input terminal via the first output terminal or the second output terminal in response to a first control signal;
a first memory connected to the first output terminal and configured to perform a plurality of outputs to output each element of the first matrix stored by the first memory in response to a second control signal, outputting a column of elements of the first matrix in parallel for each output;
a second memory connected to the second output terminal and configured to serially output each element of a second matrix in the first matrix stored by the second memory in response to a third control signal; and
a computation circuit configured to perform a pooling operation on the second matrix from the first memory or the second memory to obtain an operation result in response to a fourth control signal.

2. The chip for pooling operation according to claim 1, wherein
the first memory comprises at least one row buffer connected to the first output terminal, each row buffer being configured to store a row of elements in the first matrix.

3. The chip for pooling operation according to claim 2, wherein
each row buffer comprises one or more first-in-first-out memories that are connected in series;
wherein
the at least one row buffer comprises N row buffers, different row buffers being configured to store different rows of elements in the first matrix, N being an integer greater than or equal to 2.

4. The chip for pooling operation according to claim 3, wherein
the N row buffers are sequentially connected in series, a 1st row buffer of the N row buffers is connected to the first output terminal, an i-th row buffer is configured to output a row of elements flowing to the i-th row buffer to an (i+1)th row buffer so that different row buffers store different rows of elements in the first matrix, and i is an integer greater than or equal to 1 and less than or equal to N−1.

5. The chip for pooling operation according to claim 4, wherein
the i-th row buffer is configured to output one element to the (i+1)th row buffer each time the element is output to the computation circuit.

6. The chip for pooling operation according to claim 2, wherein
the first memory further comprises a data path connected to the first output terminal and in parallel with the at least one row buffer and configured such that a first row of elements or a last row of elements in the first matrix flow out via the data path.

7. The chip for pooling operation according to claim 1, wherein
the computation circuit is configured to determine the second matrix on the basis of the first matrix from the first memory in response to the fourth control signal and to perform the pooling operation on the second matrix to obtain the operation result.

8. The chip for pooling operation according to claim 7, wherein the second matrix comprises a 1st second matrix and a 2nd second matrix;
the computation circuit is configured to perform a first pooling operation on a plurality of first elements of the 1st second matrix to obtain a first operation result, wherein the first pooling operation comprises: performing a first operation on each column of first elements in the plurality of first elements to obtain a first intermediate result, and performing a second operation on the first intermediate result of each column of first elements to obtain the first operation result; and
the computation circuit is further configured to perform a second pooling operation on a plurality of second elements of the 2nd second matrix to obtain a second operation result, wherein at least one column of the plurality of second elements is the same as at least one column of the plurality of first elements, and the second pooling operation comprises: performing the first operation on each column of second elements of the plurality of second elements except the at least one column of second elements to obtain a second intermediate result, and performing the second operation on the first intermediate result and the second intermediate result of the at least one column of first elements to obtain the second operation result.

9. The chip for pooling operation according to claim 8, wherein the computation circuit comprises:
a first computation circuit configured to perform the first operation to obtain the first intermediate result and the second intermediate result; and
a second computation circuit configured to perform the second operation to obtain the second operation result after obtaining the first intermediate result and the second intermediate result of the at least one column of first elements by the first computation circuit;
wherein
in a case where the first intermediate result of each column of first elements is a sum of the first elements of the column, the first operation result is an average value of a plurality of first elements of the 1st second matrix, and the second operation result is an average value of a plurality of second elements of the 2nd second matrix; and
in a case where the first intermediate result of each column of first elements is a max-or-min value of the first elements of the column, the first operation result is a max-or-min value of a plurality of first elements of the 1st second matrix, and the second operation result is a max-or-min value of a plurality of second elements of the 2nd second matrix, the max-or-min value being one of a largest value and a smallest value.

10. The chip for pooling operation according to claim 1, wherein
the second memory is configured to determine the second matrix from the first matrix stored by the second memory and serially output each element of the second matrix to the computation circuit in response to the third control signal.

11. The chip for pooling operation according to claim 1, further comprising:
a multiplexer comprising a second input terminal, a third input terminal, and a third output terminal and configured to output the first matrix from the second input terminal or the second matrix from the third input terminal via the third output terminal in response to a fifth control signal, wherein the second input terminal is connected to the first memory, the third input terminal is connected to the second memory, and the third output terminal is connected to the computation circuit.

12. The chip for pooling operation according to claim 1, further comprising:
a data collator configured to collate a plurality of the operation results into a preset format and output in response to a sixth control signal.

13. The chip for pooling operation according to claim 1, further comprising:
a first controller configured to transmit a plurality of control signals, the plurality of control signals comprising the first control signal, the second control signal, the third control signal, and the fourth control signal.

14. A method for pooling operation, comprising:
outputting by a demultiplexer a first matrix from a first input terminal of the demultiplexer via a first output terminal of the demultiplexer or via a second output terminal of the demultiplexer in response to a first control signal;
performing multiple outputs by a first memory to output each element of the first matrix stored by the first memory and output a column of elements of the first matrix in parallel each time in response to a second control signal in the case where the first matrix is output via the first output terminal, the first memory being connected to the first output terminal;
outputting serially by a second memory each element of a second matrix in the first matrix stored by the second memory in response to a third control signal in the case where the first matrix is output via the second output terminal, the second memory being connected to the second output terminal; and
performing a pooling operation by a computation circuit on the second matrix from the first memory or the second memory to obtain an operation result in response to a fourth control signal.

15. The method for pooling operation according to claim 14, wherein
the first memory comprises at least one row buffer connected to the first output terminal, each row buffer storing a row of elements of the first matrix.

16. The method for pooling operation according to claim 15, wherein
each of the row buffers comprises one or more first-in-first-out memories that are connected in series;
wherein
the at least one row buffer comprises N row buffers, different row buffers storing different rows of elements in the first matrix, N being an integer greater than or equal to 2.

17. The method for pooling operation according to claim 16, wherein the N row buffers are sequentially connected in series, and a 1st row buffer of the N row buffers is connected to the first output terminal; the method further comprises:
outputting by an i-th row buffer a row of elements flowing to the i-th row buffer to an (i+1)th row buffer so that different row buffers store different rows of elements in the first matrix, where i is an integer greater than or equal to 1 and less than or equal to N−1.

18. The method for pooling operation according to claim 17, wherein
the i-th row buffer outputs one element to the (i+1)th row buffer each time the element is output to the computation circuit.

19. An accelerator for pooling operation, comprising:
the chip for pooling operation according to claim 1.

20. A system for pooling operation, comprising:
the accelerator for pooling operation according to claim 19;
a third memory configured to store a third matrix;
a direct memory access module configured to retrieve the first matrix from the third matrix and transmit to the demultiplexer in response to a seventh control signal; and
a second controller configured to transmit the seventh control signal and an eighth control signal, the eighth control signal causing the first control signal, the second control signal, the third control signal, and the fourth control signal to be transmitted.
